(19) United States
(12) Patent Application Publication
(10) Pub. No.: US 2026/0318694 A1
(43) Pub. Date: Oct. 15, 2026

(54) INFORMATION PROCESSING DEVICE AND NON-TRANSITORY STORAGE MEDIUM

(71) Applicant: TOYOTA JIDOSHA KABUSHIKI KAISHA, Toyota-shi (JP)

(72) Inventor: Makoto TAKAHASHI, Yokosuka-shi (JP)

(73) Assignee: TOYOTA JIDOSHA KABUSHIKI KAISHA, Toyota-shi (JP)

(21) Appl. No.: 19/553,790

(22) Filed: Mar. 2, 2026

(30) Foreign Application Priority Data
Apr. 10, 2025 (JP) 2025-065179

(51) Int. Cl. G01C 21/34

(52) U.S. Cl. CPC G01C 21/3415

(57) ABSTRACT

The information processing device registers the first route to the destination in the guidance route, and guides the route to the destination corresponding to the current position according to the registered guidance route. When the current position is within a predetermined range from the destination, the information processing device acquires the first expected arrival time to the destination by the guidance route calculated according to the current position. When the acquired first expected arrival time is earlier than the desired arrival time and the first time difference between the first expected arrival time and the desired arrival time exceeds the first threshold value, the information processing device proposes to the user to switch the guidance route to the second route that is the second route from the current position to the destination, is later than the first route, and arrives at the destination before the desired arrival time.

### CROSS-REFERENCE TO RELATED APPLICATION

This application claims priority to Japanese Patent Application No. 2025-065179 filed on Apr. 10, 2025. The disclosure of the above-identified application, including the specification, drawings, and claims, is incorporated by reference herein in its entirety.

### BACKGROUND

### 1. Technical Field

The present disclosure relates to an information processing device and a non-transitory storage medium.

### 2. Description of Related Art

Japanese Unexamined Patent Application Publication No. 2019-148468 (JP 2019-148468 A) proposes a navigation device that acquires a current position, a destination, and a desired arrival time, searches for a route from the acquired current position to the destination, and presents a route search result to a user. The navigation device searches for a plurality of routes in a route search step. The navigation device rearranges the routes found in the search such that routes that allow arrival at a time that is before the acquired desired arrival time and that is closer to the desired arrival time are given higher priorities. After rearranging the routes, the navigation device presents the route search result to the user.

### SUMMARY

An object of the present disclosure is to provide a technique of providing guidance on a route that allows arrival at a destination at a time that is close to a desired arrival time while suppressing the effect of a detour.

A first aspect of the present disclosure provides an information processing device including a control unit.

The control unit is configured to: acquire a first route to a destination from a search engine;

register the acquired first route as a guidance route;

acquire a current position;

provide guidance on a route to the destination corresponding to the acquired current position according to the guidance route registered;

repeatedly acquire the current position and provide guidance on the route until the acquired current position reaches the destination;

when the acquired current position is within a predetermined range from the destination, acquire a first expected arrival time at the destination by the guidance route, the first expected arrival time being calculated according to the current position;

when the acquired first expected arrival time is earlier than a desired arrival time and a first time difference between the first expected arrival time and the desired arrival time is more than a first threshold value, request the search engine to search for a second route from the current position to the destination, the second route allowing arrival at the destination that is later than by the first route and before the desired arrival time; and

suggest to a user to switch the guidance route to the second route acquired from the search engine.

A second aspect of the present disclosure provides a non-transitory storage medium storing a program causing a computer to execute an information processing method.

The information processing method includes:
acquiring a first route to a destination from a search engine;
registering the acquired first route as a guidance route;
acquiring a current position;
providing guidance on a route to the destination corresponding to the acquired current position according to the guidance route registered;
repeatedly acquiring the current position and providing guidance on the route until the acquired current position reaches the destination;
   when the acquired current position is within a predetermined range from the destination, acquiring a first expected arrival time at the destination by the guidance route, the first expected arrival time being calculated according to the current position;
      when the acquired first expected arrival time is earlier than a desired arrival time and a time difference between the first expected arrival time and the desired arrival time is more than a first threshold value, requesting the search engine to search for a second route from the current position to the destination, the second route allowing arrival at the destination that is later than by the first route and before the desired arrival time; and suggesting to a user to switch the guidance route to the second route acquired from the search engine.

According to the present disclosure, it is possible to provide a technique of providing guidance on a route that allows arrival at a destination at a time that is close to a desired arrival time while suppressing the effect of a detour.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 schematically illustrates an example of a scene to which the present disclosure is applied;

FIG. 2 schematically shows an example of a stepwise proposal;

FIG. 3 schematically illustrates an example of a scene after switching to a second route;

FIG. 4 schematically illustrates an example of a hardware configuration of an information processing device;

FIG. 5 is a flowchart illustrating an exemplary process for route guidance; and

FIG. 6 is a flowchart illustrating an example of a processing procedure related to route guidance after switching to the second route.

### DETAILED DESCRIPTION OF EMBODIMENTS

In the conventional method, a route whose expected arrival time is close to a desired arrival time can be presented at a higher level. However, the present inventors have found that this method has the following problems. That is, when the expected arrival time of the shortest route to the destination is significantly earlier than the desired arrival time, the recommended route is a route that bypasses (goes away from) the shortest route. Selecting a route that goes farther away from the destination than the departure point increases the effect of a delay in some circumstances, which increases the possibility that the actual arrival time is delayed from the desired arrival time.

On the other hand, the information processing device according to the first aspect of the present disclosure includes a control unit. The control unit is configured to perform acquiring a first route to a destination from a search engine, registering the acquired first route in a guidance route, and acquiring a current position. The control unit is configured to perform, according to the registered guidance route, guidance of the route to the destination corresponding to the acquired current position, and repeat acquisition of the current position and guidance of the route until the acquired current position reaches the destination. When the acquired current position is within a predetermined range from the destination, the control unit is configured to acquire a first expected arrival time to the destination by the guidance route calculated according to the current position. When the acquired first expected arrival time is earlier than the desired arrival time and the first time difference between the first expected arrival time and the desired arrival time exceeds the first threshold value, the control unit is configured to execute requesting the search engine to search for a second route from the current position to the destination, which is a second route later than the first route and arrives at the destination before the desired arrival time. The control unit is configured to perform suggesting to the user to switch the guidance route to the second route obtained from the search engine.

In the first aspect of the present disclosure, the execution range of the search and guidance setting of the second route, which may be farther than the first route, is narrowed down to a predetermined range from the destination. Thus, even when a delay occurs in the second route, it is possible to expect that the influence of the delay is small. Therefore, according to the first aspect of the present disclosure, it is possible to suppress the influence of bypassing and expect guidance of a route that can arrive at a destination at a time close to a desired arrival time.

Note that the embodiment of the present disclosure is not limited to the above-described information processing device. As another aspect of the information processing device according to the above aspect, an aspect of the present disclosure may be an information processing method and a program that realize at least a part of each of the above-described components. One aspect of the present disclosure may be a machine-readable storage medium, such as a computer, storing such a program. Here, the machine-readable storage medium may be a non-transitory medium that stores information such as a program by electrical, magnetic, optical, mechanical, or chemical action. The non-transitory storage medium may include a storage medium (CD, DVD, semiconductor memory, etc.), an auxiliary storage device of the computer, an external storage device connected to the computer, and the like.

For example, the program according to the second aspect of the present disclosure may be a program for causing a computer to execute an information processing method. The information processing method may include obtaining a first route to a destination from a search engine, registering the obtained first route in a guidance route, and obtaining a current position. The information processing method may include guiding a route to a destination corresponding to the acquired current position according to the registered guidance route, and repeating acquisition of the current position and guidance of the route until the acquired current position reaches the destination. The information processing method may include, when the acquired current position is within a predetermined range from the destination, acquiring a first expected arrival time to the destination by the guidance route calculated according to the current position. The information processing method may include, when the acquired first expected arrival time is earlier than the desired arrival time and the first time difference between the first expected arrival time and the desired arrival time exceeds the first threshold value, requesting the search engine to search for a second route that is a second route from the current position to the destination and that arrives at the destination later than the first route and before the desired arrival time. The information processing method may include proposing to the user to switch a guidance route to a second route obtained from the search engine.

Hereinafter, an embodiment according to an aspect of the present disclosure will be described with reference to the drawings. However, the embodiments described below are merely examples of the present disclosure in all respects. Various modifications or variations may be made without departing from the scope of the present disclosure. In the implementation of the present disclosure, a specific configuration according to the embodiment may be adopted as appropriate. Although the data appearing in the present embodiment is described in a natural language, more specifically, the data is designated by a pseudo language, a command, a parameter, a machine language, an electrical signal, or the like that can be recognized by a machine such as a computer.

### 1 Application Example

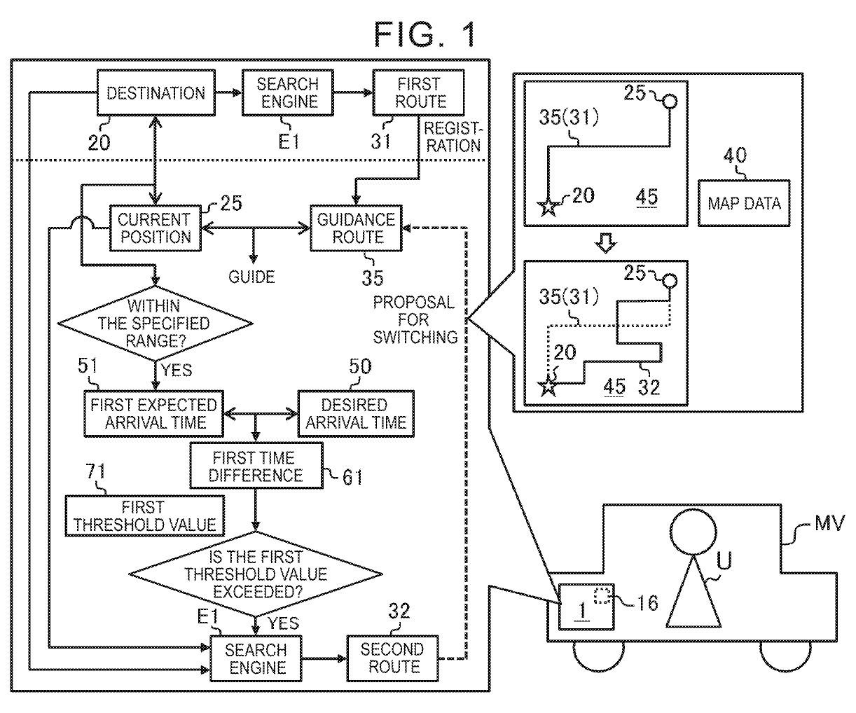

FIG. 1 schematically illustrates an example of a scene to which the present disclosure is applied. The information processing device 1 according to the present embodiment is one or more computers configured to guide a route to a destination in accordance with a current position.

In the present embodiment, the information processing device 1 acquires the first route 31 to the destination 20 from the search engine E1. The information processing device 1 registers the acquired first route 31 in the guidance route 35. The information processing device 1 acquires the current position 25 and guides the route to the destination 20 corresponding to the acquired current position 25 according to the registered guidance route 35. The information processing device 1 may continuously acquire the current position 25. The information processing device 1 repeatedly acquires the current position 25 and guides the route until the acquired current position 25 arrives at the destination 20.

When the current position 25 to be acquired is within a predetermined range from the destination 20, the information processing device 1 acquires the first expected arrival time 51 to the destination 20 by the guidance route 35, which is calculated according to the current position 25. The information processing device 1 compares the acquired first expected arrival time 51 with the desired arrival time 50. When the first expected arrival time 51 is earlier than the expected arrival time 50 and the first time difference 61 between the first expected arrival time 51 and the desired arrival time 50 exceeds the first threshold value 71, the information processing device 1 requests the search engine E1 to search the second route 32. The second route 32 is a route from the current position 25 to the destination 20, and arrives at the destination 20 later than the first route 31 and before the desired arrival time 50. The information processing device 1 proposes to the user U to switch the guidance route 35 to the second route 32 acquired from the search engine E1.

As described above, in the present embodiment, the execution range of the search and guidance setting of the second route 32 that can be farther from the first route 31 is narrowed down to a predetermined range from the destination 20. Thus, even when a delay occurs in the second route 32, it can be expected that the influence of the delay is small. Therefore, according to the present embodiment, it is possible to suppress the influence of bypassing and expect guidance of a route that can arrive at the destination 20 at a time close to the desired arrival time 50.

### User

The information processing device 1 according to the present exemplary embodiment may be utilized in any situation in which a route is guided to a user U. The user U may be any person who desires to guide the route. In one embodiment, the user U may be an occupant (driver, passenger, etc.) of the vehicle MV. The type of the vehicle MV (the number of wheels, the power source, the size, and the like) may be arbitrarily selected. The vehicle MV may include a manual driving vehicle and an autonomous driving vehicle. Here, the information processing device 1 may be an in-vehicle device mounted on the vehicle MV, or may be a user terminal carried by the user U riding on the vehicle MV. The user terminal may include a mobile terminal such as a mobile phone (including a smartphone) or a tablet terminal. However, the use scene of the information processing device 1 is not limited to such an example. In another embodiment, the information processing device 1 according to the present embodiment may be used in a scene that is moved by a moving object other than the vehicle MV or in a scene that is moved (walking or the like) without using the moving object. The information processing device 1 may be any computer other than the in-vehicle device and the user terminal.

### Search Engine

The search engine E1 is appropriately configured to be able to search a route from the departure point to the destination 20. In one instance, the search engine E1 may be further configured to be predictable of a travel time and an arrival time of the route. Known methods may be employed for predicting the travel time and the arrival time. The estimated travel time (a predicted result of the travel time) and the expected arrival time (a predicted result of the arrival time) may be calculated by reflecting the traffic situation such as the traffic jam information. A known engine for searching a route may be used as the search engine E1.

The search engine E1 may be provided on the information processing device 1 or may be provided on another computer (such as an external server) other than the information processing device 1. When the search engine E1 is deployed on the information processing device 1, acquiring a route from the search engine E1 may be configured by executing an operation of the search engine E1 to acquire a search result (operation result) of the route from the search engine E1. When the search engine E1 is deployed on another computer, obtaining the route from the search engine E1 may comprise requesting the other computer to search for the route by the search engine E1. The search engine E1 operation may be executed by another computer, and the search result (operation result) of the route by the search engine E1 may be acquired from another computer. Also, the starting point may be provided in any manner. In one example, the current position 25 measured at the starting point may be used as the starting point. The departure point may be any point in time at which a route to the destination 20 is searched. In another example, the departure point may be specified by the user U. The user U may input (designate) the departure point by directly operating the information processing device 1. The user U may indirectly enter the starting point into the information processing device 1 through other computers, such as a user terminal.

### Route Guidance

The route may be a route from the current position 25 to the destination 20. The route guidance method is not particularly limited, and may be appropriately selected according to the embodiment. As a route guidance method, a known method (a guidance method such as a navigation device) may be used.

The current position 25 may be obtained in any manner. The positioning module 16 may be used to measure the current position 25. The positioning module 16 may be deployed at any location capable of measuring the position of the user U. In an example, the positioning module 16 may be built in the information processing device 1. In another example, the positioning module 16 may be provided outside the information processing device 1. Deployment outside the information processing device 1 may include, for example, possession by the user U, deployment in a device (such as a vehicle MV) that moves in conjunction with the user U, and the like. In this case, the information processing device 1 may be directly or indirectly connected to the positioning module 16. The indirect connection may be configured by connection via a network (such as an in-vehicle network), another computer, or the like. Note that the current position 25 may be a position measured by the positioning module 16 as it is, or may be a position obtained by correcting a result measured by the positioning module 16 by an arbitrary method. The current position 25 may be a position predicted from a result measured by the positioning module 16.

The destination 20 may be a target point of the user U, and the desired arrival time 50 may be a time desired by the user U to arrive at the destination 20. The destination 20 and the desired arrival time 50 may be obtained in any manner. At least one of the destination 20 and the desired arrival time 50 may be given by an input of the user U or may be obtained from reference information such as schedule information. The reference information may be stored in at least one of a memory resource and an external storage device (including a memory resource of an external computer) of the information processing device 1, and the information processing device 1 may appropriately refer to the reference information. The desired arrival time 50 may be acquired at any timing before calculating the first time difference 61. In one example, the desired arrival time 50 may be obtained along with the destination 20 when searching the first route 31. The desired arrival time 50 may be acquired at a timing separate from the destination 20.

The criterion of whether or not the vehicle has arrived at the destination 20 may be appropriately determined according to the embodiment. In one example, arriving at the destination 20 may be configured by the current position 25 matching the destination 20, or the current position 25 belonging within a predetermined distance from the destination 20 (i.e., the current position 25 arrives around the destination 20). The predetermined distance may be appropriately defined. A known method may be adopted as a criterion as to whether or not the vehicle has arrived at the destination 20.

As illustrated in FIG. 1, a map 45 (map data 40) may be used to guide a route. The map 45 (map data 40) may be given as appropriate. The map data 40 may be appropriately configured to show the map 45. A known configuration may be adopted as the configuration of the map data 40. In one example, the map data 40 may be configured to include latitude and longitude coordinate information, road network information, facility information, and the like. The road network information may include ID of roads (road links). The map data 40 may be held in an arbitrary storage area. The map data 40 may be stored in at least one of a memory resource and an external storage device (including a memory resource of an external computer) of the information processing device 1.

In the information processing device 1, the map data 40 may be used for any purpose such as display of a designated area or a designated location, route guidance, and the like. The information processing device 1 may or may not hold the map data 40 in advance. In the latter case, the map data 40 may be held in an external storage device. The information processing device 1 may be directly connected to an external storage device, or may be indirectly connected via a network or the like. The information processing device 1 may acquire data of at least a range to be used from the map data 40 from an external storage device by an arbitrary method. As a method of acquiring the map data 40, a known method may be employed.

### 1st Route/2nd Route

The first route 31 is a route obtained by the search engine E1 prior to proposing switching to the second route 32 and adopted in the guidance route 35. In an example, the first route 31 may be the first adopted route that starts moving toward the destination 20. The starting point of the first route 31 may be a point of time when the destination 20 is changed, such as a point of time when the vehicle MV starts driving. Further, the departure point of the first route 31 may be a point in time at which the route guidance starts moving toward the destination 20 to be set, such as a point in time at which the route is first set during the movement. In this case, the first route 31 may be searched by any criterion. For example, the first route 31 may be the shortest route from the departure point to the destination 20. The shortest may be determined on any basis, such as distance (travel distance), time (travel expected time), etc. In another example, when the switching of the first route 31 to the second route 32 is repeated, the first route 31 may be the second route 32 obtained by the previous switching.

The first expected arrival time 51 may be a predicted value of a time at which the vehicle arrives at the destination 20 by moving from the current position 25 according to the guidance route 35 (the first route 31). The first expected arrival time 51 may be appropriately calculated based on the current position 25 and the guidance route 35 (the first route 31) obtained at an arbitrary timing after the user U moves within a predetermined range (a range of a predetermined distance) from the destination 20. A known method may be employed for calculating the first expected arrival time 51 (estimating the arrival time). search engine E1 may be used to calculate the first expected arrival time 51. The first expected arrival time 51 may be calculated in other ways without using a search engine E1. The calculation of the first expected arrival time 51 may be executed on the information processing device 1 or may be executed by another computer (such as an external server) other than the information processing device 1. Obtaining the first expected arrival time 51 may be configured by performing a calculation of the first expected arrival time 51. Obtaining the first expected arrival time 51 may be configured by requesting a calculation of the first expected arrival time 51 from another computer and obtaining a calculation result of the first expected arrival time 51 from another computer.

The second route 32 may be a route that arrives at the destination 20 later than the first route 31 and can arrive at the destination 20 before the desired arrival time 50. In one example, the second route 32 may be a route that diverts within a predetermined range from the destination 20, such as descending at an exit in front of one of the highways, navigating to a large street, or the like. The method of searching for the second route 32 is not particularly limited, and may be appropriately selected according to the embodiment. As a method of searching the second route 32, a known method of searching for a detour route may be employed.

The predetermined range is a range that serves as a reference for starting (permitting) the proposal of the second route 32 that bypasses the first route 31. The predetermined range may be appropriately defined according to the embodiment. The smaller the predetermined range is, the closer to the destination 20 is moved, so that it is possible to suppress the influence of the delay at the time of bypassing by selecting the second route 32. However, it is difficult to extend the time due to the detour, and there is a possibility that a route that passes through the same route multiple times is proposed as the second route 32. The predetermined range may be appropriately defined based on this aspect. Further, the predetermined range may be defined by any method. In one example, the predetermined range may be defined by a linear distance from the destination 20, may be defined by a travel distance to the destination 20, or may be defined by an expected travel time to the destination 20. The reference value (distance, time, etc.) defining the predetermined range may be arbitrarily defined.

### Make a Proposal

A method of proposing switching of the guidance route 35 is not particularly limited, and may be appropriately selected according to the embodiment. In one example, proposing to switch the guidance route 35 may be configured by querying the user U whether or not to switch the guidance route 35. The information processing device 1 may switch the guidance route 35 from the first route 31 to the second route 32 in response to receiving an affirmative answer (selection operation, voice answer, etc.) to the inquiry from the user U. In the following embodiments, for the sake of convenience, it is assumed that this method is adopted as a method for proposing switching of the guidance route 35. However, the method of proposing the switching of the guidance route 35 is not limited to such an example. In another example, proposing to switch the guidance route 35 may be configured by automatically switching the guidance route 35. In this case, the information processing device 1 may output, to the user U, a notification indicating that the guidance route 35 has been switched from the first route 31 to the second route 32.

Whether or not to execute a process of proposing switching of the guidance route 35 from the set route (first route 31) to another route (second route 32) may be controlled as appropriate. In an example, whether to permit switching to another route may be set in advance. Whether or not switching to another route is permitted may be managed by setting information such as a flag. The setting information may be stored in a memory resource of the information processing device 1 as appropriate. The user U may appropriately set whether or not switching to another route is permitted by directly operating the information processing device 1 or indirectly operating via another computer (terminal or the like). The information processing device 1 may be configured to execute a process of proposing switching to the second route 32 only when switching to another route is permitted by referring to the setting information.

### Step-by-step Proposal

In an example, the information processing device 1 may be configured to propose a measure for prompting arrival at a time close to the desired arrival time 50 in a stepwise manner. For example, in a case where the first time difference 61 is less than the first threshold value 71, the information processing device 1 may propose a second measure for prompting arrival at a time close to the desired arrival time 50 other than the detour by the second route 32 (the first measure). The second strategy may be a strategy that consumes less time than the divert by the second route 32. In addition, when the first time difference 61 is larger than the first threshold value 71 by more than a predetermined value, the information processing device 1 may propose a third measure for prompting arrival at a time close to the desired arrival time 50 other than the detour by the second route 32 (the first measure) and the second measure. As the third measure, a measure that is easier to consume time than the detour by the second route 32 may be selected. The predetermined value may be arbitrarily defined.

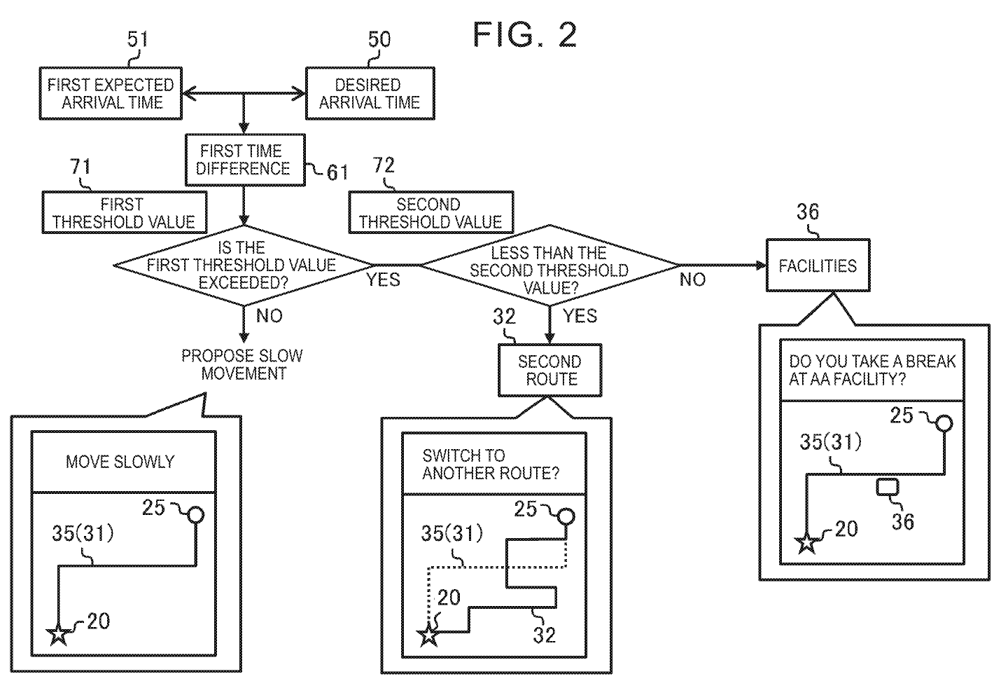

FIG. 2 schematically illustrates an example of a stepwise proposal by the information processing device 1 according to the present embodiment. In an example, the information processing device 1 may compare the first expected arrival time 51 with the desired arrival time 50. Further, the information processing device 1 may calculate the first time difference 61 between the first expected arrival time 51 and the desired arrival time 50, and compare the calculated first time difference 61 with the first threshold value 71. When the first expected arrival time 51 is earlier than the desired arrival time 50 and the first time difference 61 is less than the first threshold value 71, the information processing device 1 may propose movement at a speed slower than the current movement speed. Movement at a speed slower than the current movement speed is an example of the second measure. The first threshold value 71 may be arbitrarily defined. The fact that the first time difference 61 is equal to the first threshold value 71 may be treated as any of the fact that the first time difference 61 is less than the first threshold value 71 and the fact that the first time difference 61 exceeds the first threshold value 71.

The method of proposing the movement at a slow speed is not particularly limited, and may be appropriately determined according to the embodiment. The information processing device 1 may propose moving at a low speed in an arbitrary output format such as image output or audio output. In addition, in an example, the information processing device 1 may propose a movement at a speed lower than the current movement speed without specifying a degree of lowering the movement speed, such as "Let's move slowly" in FIG. 2. In another example, the information processing device 1 may propose the movement at a speed lower than the current movement speed by specifying the degree of lowering the movement speed according to the speed of lowering from the current movement speed, the movement speed after the lowering, or the like. The degree to which the moving speed is decreased may be appropriately calculated from the first time difference 61. According to an example of the present embodiment, in a case where the arrival does not arrive earlier as the second route 32 is switched, the arrival at a time closer to the desired arrival time 50 can be expected by proposing the movement at a speed slower than the current movement speed.

Further, in an example, when the first time difference 61 exceeds the first threshold value 71, the information processing device 1 may further compare the first time difference 61 with the second threshold value 72 larger than the first threshold value 71. Requesting the search of the second route 32 to the search engine E1 may be performed when the first expected arrival time 51 is earlier than the desired arrival time 50, the first time difference 61 exceeds the first threshold value 71, and the first time difference 61 is less than the second threshold value 72. The second threshold value 72 may be appropriately set to a value larger than the first threshold value 71. The fact that the first time difference 61 is equal to the second threshold value 72 may be treated as either that the first time difference 61 is less than the second threshold value 72 or that the first time difference 61 is greater than the second threshold value 72. The method of inquiring about switching to the second route 32 is not particularly limited, and may be appropriately determined according to the embodiment. The information processing device 1 may inquire whether or not to switch the guidance route 35 to the second route 32 in an arbitrary output format such as image output or audio output. For example, the information processing device 1 may output an announcement such as "Switch to another route" and present the second route 32 to inquire whether or not to switch to the second route 32. On the other hand, in a case where the first expected arrival time 51 is earlier than the desired arrival time 50 and the first time difference 61 exceeds the second threshold value 72, the information processing device 1 may propose staying on the guidance route 35 or at the facility 36 existing in the vicinity of the guidance route 35. The stay at the facility 36 is an example of a third measure.

The method of searching for the facility 36 is not particularly limited, and may be appropriately selected according to the embodiment. As a search method for the facility 36, a known method such as a facility search on a map may be employed. A search engine E1 may be used to search for the facilities 36. The search of the facility 36 may be executed on the information processing device 1 or may be executed by another computer (such as an external server) other than the information processing device 1. In an example, the map data 40 may include facility information, and the information processing device 1 may search the facility 36 in the map data 40. In another example, the information processing device 1 may request the other computer to search for the facility 36 and acquire the search result of the facility 36 from the other computer. The facility 36 may be appropriately retrieved from the guidance route 35 and the vicinity of the guidance route 35 on a map (map 45). The range in the vicinity of the guidance route 35 may be appropriately defined according to the embodiment.

The facility 36 may be selected as appropriate from the facilities where the user U can stay. For example, when the user U is an occupant of the vehicle MV, a facility capable of stopping the vehicle MV may be searched as the facility 36. The facility capable of stopping the vehicle MV may be, for example, a parking lot, a facility having a parking lot, or the like. A facility having a parking lot may include, for example, a restaurant, a convenience store, a shopping center, a shopping mall, etc. When the vehicle MV is a large vehicle, a facility capable of stopping the large vehicle may be searched as the facility 36. The search conditions (moving conditions such as the type of MV of vehicles to be used) of the facilities 36 may be given in any manner. For example, the search condition may be designated in advance by the user U, and may be held in a memory resource of the information processing device 1. For example, when a moving condition of the user U is specified in advance, such as limited to a case where a vehicle MV of a predetermined vehicle type is used, the search condition may be defined in advance as a fixed value in the program. Further, for example, when searching for the facility 36, the search condition may be given by an answer obtained by inquiring the user U.

The method of proposing stay at the facility 36 may be similar to the method of proposing switching of the guidance route 35. In an example, the information processing device 1 may inquire of the user U whether or not to stay in the facility 36. The method of inquiring whether to stay in the facility 36 is not particularly limited, and may be appropriately determined according to the embodiment. The information processing device 1 may inquire whether to stay in the facility 36 in an arbitrary output format such as image output or audio output. For example, the information processing device 1 may inquire whether to stay at the facility 36 by outputting an announcement such as "Do you want to rest at AA facility (facility name)" and presenting the location of the facility 36. The information processing device 1 may start guidance to guide the facility 36 in response to receiving an affirmative answer (selection operation, voice answer, and the like) to the inquiry from the user U. In the following embodiment, for the sake of convenience, it will be described that this method is adopted as a proposal method of staying in the facility 36, similar to the proposal of switching of the guidance route 35. In another example, the information processing device 1 may automatically decide to stay in the facility 36. In this case, the information processing device 1 may output, to the user U, a notification indicating that the user has decided to stay in the facility 36, and may start a guidance for guidance to the facility 36.

In the case of proposing stay at the facility 36, in one example, the information processing device 1 may further propose a time (recommended stay time) for recommending stay at the facility 36. The recommended stay time may be determined as appropriate from the first time difference 61. The recommended stay time may be determined at any time smaller than the first time difference 61. When proposing to stay at a facility 36 that is not on the guidance route 35, the information processing device 1 may acquire an additional time (guidance time) required for guidance to the facility 36. The guidance time may be calculated in a manner similar to the first expected arrival time 51. The recommended stay time may be appropriately determined from the first time difference 61 and the guidance time. The recommended residence time may be determined at any time smaller than the time obtained by subtracting the induction time from the first time difference 61. This suggested stay time may be omitted.

When the first expected arrival time 51 is earlier than the desired arrival time 50 and the second route 32 that bypasses the first route 31 is searched so that the expected arrival time approaches the desired arrival time 50, the bypassing distance becomes longer. The increase in the diverting distance may lead to an increase in energy consumption for movement. On the other hand, according to an example of the present embodiment, in a case where it is predicted that the arrival is earlier as the second threshold value 72 is exceeded, it is possible to prompt staying in the facility 36 instead of being bypassed by the second route 32. As a result, it is possible to suppress the possibility of an increase in energy consumption and to expect an arrival at a time close to the desired arrival time 50. Incidentally, the stepwise proposal of a measure for urging arrival at a time close to the desired arrival time 50 is not limited to the example of FIG. 2, and may be appropriately changed according to the embodiment. Also, at least one of suggesting moving at a speed slower than the current moving speed and suggesting staying at the facility 36 may be omitted. In another example, the information processing device 1 may be configured to propose only a bypass in the second route 32.

### Example of Processing After Switching to the Second Route

After switching the guidance route 35 to the second route 32, the information processing device 1 may continuously execute the route guidance according to the guidance route 35 (the second route 32). The information processing device 1 may continue route guidance by the second route 32 until it arrives at the destination 20, or may propose switching to another route while moving according to the second route 32.

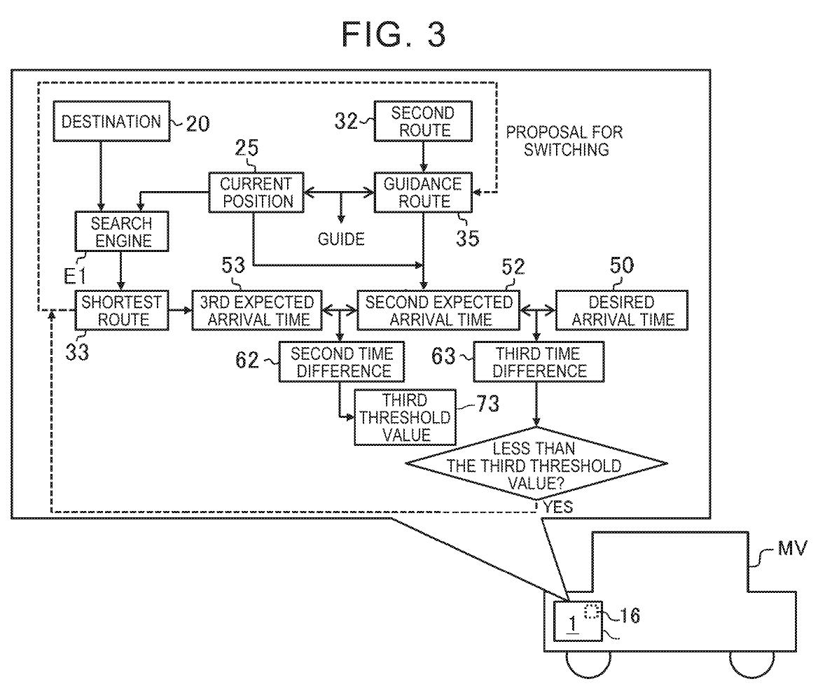

FIG. 3 schematically illustrates an example of a scene after switching to the second route 32 in the present embodiment. In an example, after the guidance route 35 is switched to the second route 32 in response to the proposal of switching to the second route 32, the information processing device 1 may repeatedly acquire the current position 25 and guide the route until the acquired current position 25 arrives at the destination 20. In an example, in response to the proposal of switching to the second route 32, the information processing device 1 may acquire the current position 25 after the guidance route 35 is switched to the second route 32. The information processing device 1 may repeatedly acquire the current position 25 and guide the route until the acquired current position 25 arrives at the destination 20. The information processing device 1 may request the search engine E1 to search for the shortest route 33 from the obtained current position 25 to the destination 20. The shortest may be determined on any basis, such as distance (travel distance), time (travel expected time), etc.

The information processing device 1 may acquire the second expected arrival time 52 to the destination 20 by the guidance route 35, which is calculated according to the acquired current position 25. The information processing device 1 may further acquire the third expected arrival time 53 to the destination 20 by the shortest route 33 acquired from the search engine E1. The second expected arrival time 52 may be a predicted value of a time at which the vehicle arrives at the destination 20 by moving from the current position 25 according to the guidance route 35 (the second route 32). The third expected arrival time 53 may be a predicted value of a time at which the user arrives at the destination 20 by moving from the current position 25 according to the shortest route 33. The second expected arrival time 52 may be calculated in a manner similar to the first expected arrival time 51, except that the calculation time is different and the calculation route replaces the first route 31 with the second route 32. The third expected arrival time 53 may be calculated in a manner similar to the second expected arrival time 52, except that the calculated route replaces the shortest route 33 from the second route 32. The information processing device 1 may calculate a second time difference 62 between the second expected arrival time 52 and the third expected arrival time 53. The information processing device 1 may set the third threshold values 73 according to the second time differences 62 between the third expected arrival time 53 and the second expected arrival time 52 to the destination 20 by the shortest route 33 acquired from the search engine E1.

The third threshold value 73 is a reference value for proposing switching to the shortest route 33. The fact that the second time difference 62 is large corresponds to the fact that the shortest route 33 enables a large recovery (shortening of the travel time). Based on this aspect, the third threshold value 73 may be set to a smaller value as the second time difference 62 increases. On the other hand, the small second time difference 62 corresponds to the small recovery by the shortest route 33. Based on this aspect, the third threshold value 73 may be set to a larger value as the second time difference 62 is smaller. The correspondence relationship between the third threshold value 73 and the second time difference 62 is not particularly limited as long as the correspondence relationship can be set as described above, and may be appropriately defined according to the embodiment. The third threshold value 73 may be set to a discrete value or a continuous value.

The information processing device 1 may compare the second expected arrival time 52 with the desired arrival time 50. Further, the information processing device 1 may calculate the third time difference 63 between the second expected arrival time 52 and the desired arrival time 50. The information processing device 1 may compare the calculated third time difference 63 with the third threshold value 73. When the second expected arrival time 52 is earlier than the desired arrival time 50 and the third time difference 63 is less than the third threshold value 73, the user U may be suggested to switch the guidance route 35 to the shortest route 33. The fact that the third time difference 63 is equal to the third threshold value 73 may be treated as any of the fact that the third time difference 63 is less than the third threshold value 73 and the fact that the third time difference 63 exceeds the third threshold value 73. The method of proposing switching to the shortest route 33 may be similar to the method of proposing switching to the second route 32.

After the guidance route 35 is switched to the second route 32, a situation may occur in which the arrival time at the second route 32 is delayed according to the traveling situation such as the occurrence of a traffic jam. According to an example of the present embodiment, by switching to the shortest route 33 before the second route 32 cannot arrive by the desired arrival time 50, it is possible to reduce the possibility of arrival late at the desired arrival time 50. The large second time difference 62 between the third expected arrival time 53 and the second expected arrival time 52 corresponds to a large recovery (shortening of the travel time) by the shortest route 33. In such a case, the guidance on the second route 32 can be prioritized by reducing the third threshold value 73. As a result, it is possible to expect arrival at a time close to the desired arrival time 50.

Note that, even when the second expected arrival time 52 is later than the desired arrival time 50, the information processing device 1 may propose a switch to the shortest route 33 to the user U. In another example, the third threshold value 73 may be further defined based on other indicators than the second time difference 62. For example, the information processing device 1 may acquire the expected arrival time to the destination 20 by the second route 32 (the guidance route 35) at the beginning of switching the guidance route 35 to the second route 32. The information processing device 1 may set the third threshold value 73 to a value smaller than a time difference between the acquired expected arrival time and the desired arrival time 50. Accordingly, it is possible to propose switching to the shortest route 33 only when a delay occurs in the movement in the second route 32 than the initial prediction of the switching. In another example, a series of processes for proposing switching to the shortest route 33 may be omitted.

### Two Configuration Examples

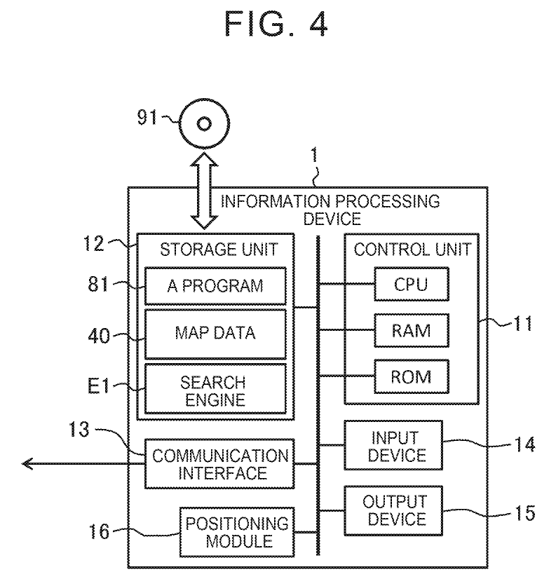

FIG. 4 schematically illustrates an example of a hardware configuration of the information processing device 1 according to the present embodiment. In an example, the information processing device 1 may be configured as a computer in which the control unit 11, the storage unit 12, the communication interface 13, the input device 14, the output device 15, and the positioning module 16 are electrically connected to each other.

The control unit 11 is configured to execute information processing based on a program and various data. For example, the control unit 11 may include CPU (Central Processing Unit), RAM (Random Access Memory), ROM (Read Only Memory), and the like, which are hardware processors. The control unit 11 (CPU) is an exemplary processor resource.

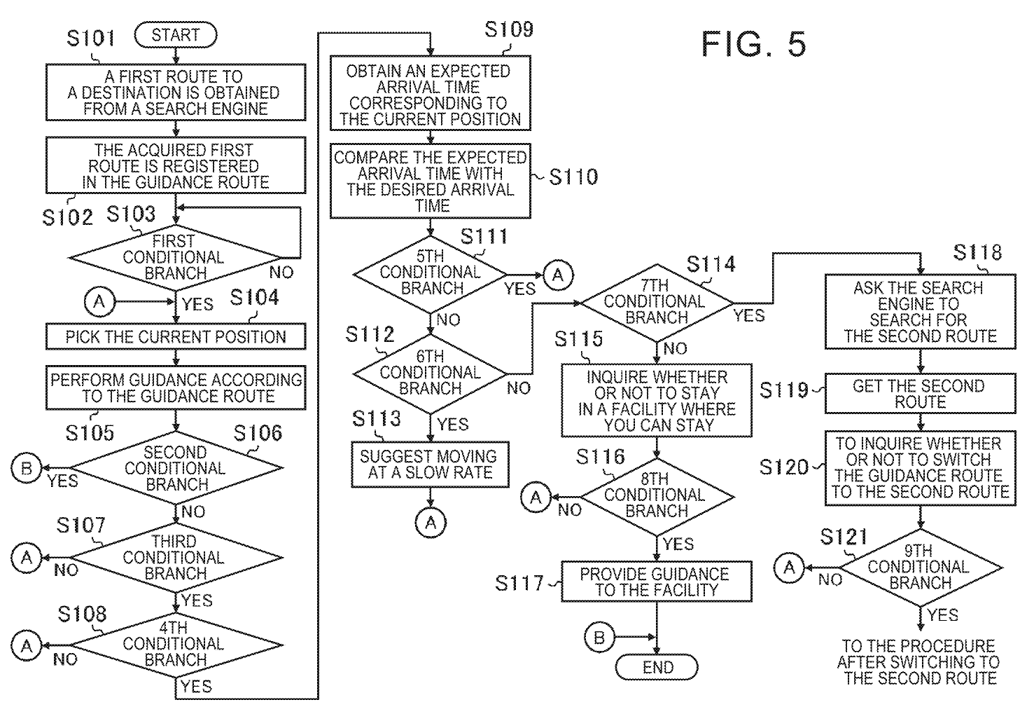

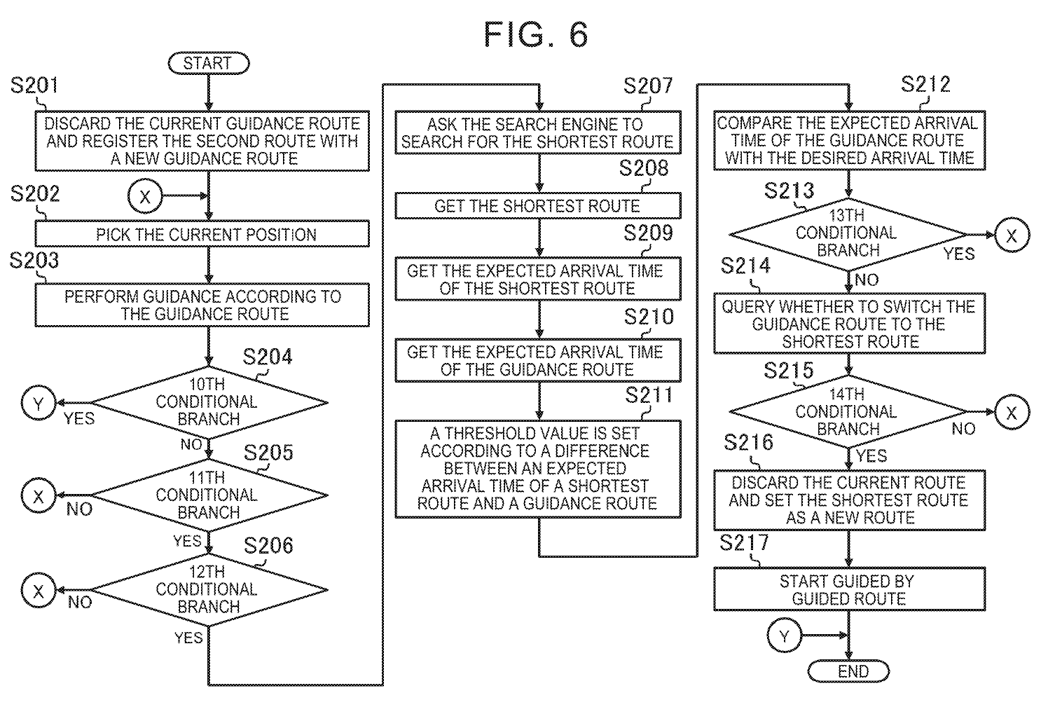

The storage unit 12 is configured to hold arbitrary data. For example, the storage unit 12 may include a hard disk drive, a solid state drive, a semiconductor memory, and the like. The storage unit 12, RAM, and ROM are exemplary memory/resources of the information processing device 1. In one embodiment, the storage unit 12 may store various types of information such as the program 81, the map data 40, and the search engine E1 (data of the search engine). The program 81 is a program for causing the information processing device 1 to execute information processing related to route guidance (FIGS. 5 and 6 described later). The program 81 includes a series of instructions for the information processing.

In one embodiment, at least one of the program 81, the map data 40, and the search engine E1 may be stored in the storage medium 91 in place of the storage unit 12 or together with the storage unit 12. The storage medium 91 is configured to store various kinds of information (such as stored programs) by electrical, magnetic, optical, mechanical or chemical action so that a machine such as a computer can read the information. The storage unit 12 and the storage medium 91 are examples of non-transitory storage media. The information processing device 1 may acquire at least one of the program 81, the map data 40, and the search engine E1 from the storage medium 91. The storage medium 91 may be a disk type storage medium (such as a CD, DVD) or a storage medium other than a disk type of a semiconductor memory (such as a flash memory). Any drive device may be used for reading the information stored in the storage medium 91. The type of the drive device may be selected according to the storage medium 91. The drive device may be connected to the information processing device 1 by any method. The storage medium 91 may include an external storage device connectable to the information processing device 1. At least one of the map data 40 and the search engine E1 may be stored in a memory-resource of a computer other than the information processing device 1. The map data 40 may be acquired only in a range to be used. The search engine E1 may be embedded within the program 81. When the search engine E1 is calculated on another computer, the search engine E1 may be omitted from the storage unit 12.

The communication interface 13 is configured to perform wired or wireless communication via a network. The communication interface 13 may be configured by, for example, a wired LAN (Local Area Network) module, a radio LAN module, or the like. The network standard is not particularly limited, and may be appropriately selected according to the embodiment. For example, the type of network may be appropriately selected from the Internet, a wireless communication network, a mobile communication network, a telephone network, a dedicated network, or the like. The information processing device 1 may perform data communication with another computer via the communication interface 13.

The input device 14 is configured to receive an input of information. The input device 14 may include, for example, a mouse, a keyboard, a touch panel, a touch pad, an operator, a microphone, and the like. The output device 15 is configured to output information. The output device 15 may be constituted by, for example, a display, a speaker, or the like. The user U can operate the information processing device 1 using the input device 14 and the output device 15. In an example, the information processing device 1 may output each inquiry via the output device 15, and may receive an answer to each inquiry via the input device 14. The input device 14 and the output device 15 may not be directly connected to the information processing device 1, and may be indirectly connected via an external interface. The external interface may be appropriately configured to be connected to an external device by, for example, a USB (Universal Serial Bus) port, a dedicated port, or the like, by a wire or wirelessly. The input device 14 and the output device 15 may be integrally formed by at least a part of a touch panel display or the like.

The positioning module 16 is configured to measure a position. As long as the position can be measured, the type of the positioning module 16 is not particularly limited, and may be appropriately selected according to the embodiment. For example, the positioning module 16 may comprise a GPS (Global Positioning System) sensor, a GNSS (Global Navigation Satellite System) sensor, or the like. Further, for example, the positioning module 16 may be configured to estimate the distance to each base station according to the strength of a signal received from each base station (radio access point). The positioning module 16 may be configured to measure the position in any manner (such as three-point surveying) from the estimated distance to each base station. In this case, the positioning module 16 may be at least partially common to the communication interface 13. In one embodiment, the positioning module 16 may comprise a control unit 11 (CPU) and a communication interface 13. The type of the base station may be appropriately selected according to the embodiment. The positioning module 16 may not be built in the information processing device 1, and may be connected to the information processing device 1 via an external interface.

Regarding the specific hardware configuration of the information processing device 1, it is possible to omit, replace, and add constituent elements as appropriate depending on the embodiment. For example, the control unit 11 may include a plurality of hardware processors. The hardware processor may include a microprocessor, an FPGA (Field-Programmable Gate Array), a DSP (Digital Signal Processor), an ECU (Electronic Control Unit), a GPU (Graphics Processing Unit), an ASIC (Application Specific Integrated Circuit), and the like. At least one of the communication interface 13, the input device 14, and the output device 15 may be omitted. The program 81, the map data 40, and/or the search engine E1 may be stored in an external storage device such as a NAS (Network Attached Storage). The external storage device is also an example of a non-transitory storage medium. The information processing device 1 may include a plurality of computers. In this case, the hardware configurations of the computers may or may not be identical. The information processing device 1 may be a general-purpose server device, a general-purpose PC (Personal Computer), a notebook PC, an in-vehicle device, a user terminal, or the like, in addition to a computer designed exclusively for a service to be provided.

### 3 Operation Example

FIG. 5 is a flowchart illustrating an example of a processing procedure related to route guidance according to the present embodiment. FIG. 6 is a flowchart illustrating an example of a processing procedure related to route guidance after switching the guidance route 35 to the second route 32 according to the present embodiment. The control unit 11 of the information processing device 1 executes an instruction included in the program 81 held in the storage unit 12. Thus, the control unit 11 is configured to execute the following information processing, and the information processing device 1 operates as a computer capable of executing the following information processing. The following processing procedure is an example of an information processing method executed by a computer. However, the following processing procedure is merely an example, and each step may be changed as much as possible.

The control unit 11 may start the execution of the processing procedure of FIG. 5 in a state where switching to another route is permitted. In S101, the control unit 11 acquires the first route 31 to the destination 20 from the search engine E1. In S102, the control unit 11 registers the acquired first route 31 in the guidance route 35. In S103, the control unit 11 detects whether or not the user U is moving (first conditional branch). The movement of the user U can be detected in any way. For example, when the user U is an occupant of the vehicle MV and the information processing device 1 is an in-vehicle device, the control unit 11 may detect the movement of the user U (vehicle MV) in accordance with whether or not the user U is operated with respect to equipment of the vehicle MV such as an ignition, an accelerator pedal, or the like. Further, for example, the control unit 11 may detect movement of the user U based on measurement data of an arbitrary sensor such as an acceleration sensor or a gyro sensor. When the motion of the user U is not detected, the control unit 11 repeats S103 process. When the movement of the user U is detected, the control unit 11 advances the process to the following S104.

In S104, the control unit 11 acquires the current position 25 of the user U. In S105, the control unit 11 guides the route to the destination 20 corresponding to the acquired current position 25 in accordance with the registered guidance route 35. In S106, the control unit 11 determines whether or not the current position 25 has arrived at the destination 20 (second conditional branch). When the current position 25 arrives at the destination 20, the control unit 11 ends the processing procedure according to this operation example. When the current position 25 has not arrived at the destination 20, the control unit 11 advances the process to the following S107. In S107, the control unit 11 determines whether or not the current position 25 is within a predetermined range from the destination 20 (third conditional branch). When the current position 25 is not within the predetermined range from the destination 20, the control unit 11 returns the process to S104 and repeats the process from S104. By executing the process from S104 again, the control unit 11 repeatedly acquires (S104) the current position 25 and guides (S105) the route until the current position 25 reaches the destination 20. When the current position 25 is within the predetermined range from the destination 20, the control unit 11 advances the process to the following S108.

In S108, the control unit 11 determines whether or not switching to another route (second route 32) is permitted (fourth conditional branch). When switching to another route is not permitted, the control unit 11 returns the process to S104 and repeats the process from S104. When switching to another route is permitted, the control unit 11 advances the process to the following S109. In S109, the control unit 11 acquires the first expected arrival time 51 of the guidance route 35 to the destination 20, which is calculated according to the current position 25. In S110, the control unit 11 compares the acquired first expected arrival time 51 with the desired arrival time 50. In S111, the control unit 11 determines whether the first expected arrival time 51 is later than the desired arrival time 50 (fifth conditional branch). When the first expected arrival time 51 is later than the desired arrival time 50, the control unit 11 returns the process to S104 and repeats the process from S104. When the first expected arrival time 51 is earlier than the desired arrival time 50, the control unit 11 advances the process to the following S112. In S112, the control unit 11 calculates the first time difference 61 between the first expected arrival time 51 and the desired arrival time 50, and compares the calculated first time difference 61 with the first threshold values 71. The control unit 11 determines whether or not the first time difference 61 is less than the first threshold value 71 (sixth conditional branch). When the first time difference 61 is less than the first threshold value 71, the control unit 11 advances the process to S113. On the other hand, when the first time difference 61 exceeds the first threshold value 71, the control unit 11 advances the process to S114. When the first time difference 61 is equal to the first threshold value 71, the control unit 11 may proceed to either S113 or S114.

In S113, the control unit 11 proposes movement at a speed slower than the present movement speed. After proposing to move at a slow rate, the control unit 11 returns the process to S104 and repeats the process from S104. At this time, in an exemplary embodiment, the control unit 11 may disable switching to another route and then return the process to S104. The control unit 11 may return the process to S104 while allowing switching to another route.

In S114, the control unit 11 compares the first time difference 61 with the second threshold value 72 to determine whether or not the first time difference 61 is less than the second threshold value 72 (seventh conditional branch). When the first time difference 61 exceeds the second threshold value 72, the control unit 11 advances the process to S115. When the first time difference 61 is less than the second threshold value 72, the control unit 11 advances the process to S118. When the first time difference 61 is equal to the second threshold value 72, the control unit 11 may proceed to either S115 or S118.

In S115, the control unit 11 searches for the facilities 36 existing on the guidance route 35 or in the vicinity of the guidance route 35. The control unit 11 inquires whether to stay in the retrieved facility 36. In S116, the control unit 11 receives an answer from the user U. The control unit 11, in response to the response to the response from the user U, it is determined whether the user U is affirmative stay at the facility 36 (eighth condition branch). When the user U is affirmative stay in the facilities 36, the control unit 11 advances the process to S117. On the other hand, when the user U does not affirm (denies) the stay in the facility 36, the control unit 11 returns the process to S104 and repeats the process from S104. At this time, in an exemplary embodiment, the control unit 11 may disable switching to another route and then return the process to S104. The control unit 11 may return the process to S104 while allowing switching to another route. In S117, the control unit 11 executes guidance guided to the facilities 36. When the guidance to the facility 36 is completed, the control unit 11 ends the processing procedure according to this operation example.

In S118, the control unit 11 requests the search engine E1 to search for the second route 32. In S119, the control unit 11 acquires the second route 32 from the search engine E1. In S120, the control unit 11 inquires of the user U whether or not to switch the guidance route 35 to the second route 32. In S121, the control unit 11 receives an answer from the user U. In response to the answer from the user U, the control unit 11 determines whether or not the user U affirms switching the guidance route 35 to the second route 32 (ninth conditional branch). When the user U affirms the switching to the second route 32, the control unit 11 proceeds to the processing procedure after the switching to the second route 32 in FIG. 6. When the user U does not affirm the switch to the second route 32 (i.e., the switch is negative), the control unit 11 returns the process to S104 and repeats the process from S104. At this time, in an exemplary embodiment, the control unit 11 may disable switching to another route and then return the process to S104. The control unit 11 may return the process to S104 while allowing switching to another route.

As illustrated in FIG. 6, in S201, the control unit 11 discards the present guidance route 35 (first route 31) and registers the second route 32 in the new guidance route 35. Accordingly, the guidance route 35 is switched to the second route 32. In S202, the control unit 11 acquires the current position 25 of the user U. In S203, the control unit 11 guides the route to the destination 20 corresponding to the acquired current position 25 in accordance with the registered guidance route 35 (second route 32). In S204, the control unit 11 determines whether or not the current position 25 has arrived at the destination 20 (tenth conditional branch). When the current position 25 of the user U arrives at the destination 20, the control unit 11 ends the processing procedure according to this operation example. When the current position 25 of the user U has not arrived at the destination 20, the control unit 11 advances the process to the following S205.

In S205, it is determined whether switching to another route (shortest route 33) is permitted (eleventh conditional branch). When switching to another route is not permitted, the control unit 11 returns the process to S202 and repeats the process from S202. By executing the process from S202 again, the control unit 11 repeatedly acquires (S202) the current position 25 and guides (S203) the route until the current position 25 reaches the destination 20. When switching to another route is permitted, the control unit 11 advances the process to the following S206. In S206, the control unit 11 determines whether or not a certain period of time has elapsed from the later one of the time point at which the guidance route 35 is switched to the second route 32 and the time point at which the switching to the shortest route 33 is proposed (twelfth branch condition). When the predetermined period has not elapsed, the control unit 11 returns the process to S202 and repeats the process from S202. When the predetermined period has elapsed, the control unit 11 advances the process to S207.

In S207, the control unit 11 requests the search engine E1 to search for the shortest route 33 from the current position 25 to the destination 20. In S208, the control unit 11 acquires the shortest route 33 from the search engine E1. In S209, the control unit 11 acquires the third expected arrival time 53 of the shortest route 33 to the destination 20, which is calculated in accordance with the obtained current position 25. In one instance, the third expected arrival time 53 may be obtained from the search engine E1 along with the shortest route 33. In S210, the control unit 11 acquires the second expected arrival time 52 to the destination 20 by the guidance route 35 (the second route 32) calculated according to the obtained current position 25. The timing at which S210 process is executed is not limited to the above-described example, and may be appropriately changed according to the embodiment. S210 process may be performed at any timing after S202 and prior to S211. S210 process may be performed prior to S207. In S211, the control unit 11 calculates the second time difference 62 between the second expected arrival time 52 and the third expected arrival time 53, and sets the third threshold values 73 according to the calculated second time difference 62. The control unit 11 sets the third threshold value 73 to a smaller value as the second time difference 62 increases, and sets the third threshold value 73 to a larger value as the second time difference 62 decreases.

In S212, the control unit 11 compares the second expected arrival time 52 with the desired arrival time 50. Further, the control unit 11 calculates a third time difference 63 between the second expected arrival time 52 and the desired arrival time 50. The control unit 11 compares the calculated third time difference 63 with the third threshold value 73. In S213, the control unit 11 determines whether the second expected arrival time 52 is earlier than the desired arrival time 50 by exceeding the third threshold values 73 (thirteenth conditional branch). When the second expected arrival time 52 is later than the desired arrival time 50 or the second expected arrival time 52 is earlier than the desired arrival time 50, but the third time difference 63 is less than the third threshold value 73, the control unit 11 advances the process to S214. When the second expected arrival time 52 is earlier than the desired arrival time 50 by exceeding the third threshold value 73, the control unit 11 returns the process to S202 and repeats the process from S202. When the second expected arrival time 52 is earlier than the desired arrival time 50 and the third time difference 63 is equal to the third threshold value 73, the control unit 11 may proceed to either S202 or S214.

In S214, the control unit 11 inquires of the user U whether or not to switch the guidance route 35 to the shortest route 33. In S215, the control unit 11 receives an answer from the user U. In response to the answer from the user U, the control unit 11 determines whether or not the user U affirms that the guidance route 35 is switched to the shortest route 33 (fourteenth conditional branch). When the user U affirms switching to the shortest route 33, the control unit 11 advances the process to S216. When the user U does not affirm the switch to the shortest route 33 (denied), the control unit 11 returns the process to S202, repeats the process from S202. At this time, in an exemplary embodiment, the control unit 11 may disable switching to another route and then return the process to S202. The control unit 11 may return the process to S202 while allowing switching to another route.

In S216, the control unit 11 discards the present guidance route 35 (second route 32) and registers the shortest route 33 in the new guidance route 35. Accordingly, the guidance route 35 is switched to the shortest route 33. In S217, the control unit 11 starts guidance according to the registered new guidance route 35. The route guidance may be executed in a process similar to that of S202 and S203. When the guidance according to the guidance route 35 is completed, the control unit 11 ends the processing procedure according to this operation example.

### Features

In the present embodiment, S107 process narrows the running range of the search and guidance setting (the process after S118) of the second route 32, which may be farther from the first route 31, to a predetermined range from the destination 20. Thus, even when a delay occurs in the second route 32, it can be expected that the influence of the delay is small. Therefore, according to the present embodiment, it is possible to suppress the influence of bypassing and expect guidance of a route that can arrive at the destination 20 at a time close to the desired arrival time 50.

### 4 Modification

While embodiments of the present disclosure have been described in detail above, the foregoing description is merely illustrative of the present disclosure in all respects. The processes and means described in this disclosure can be freely combined and implemented as long as there is no technical inconsistency. In the above embodiment, various modifications or changes may be made as appropriate.

Further, the processing procedure of the information processing device 1 according to the above-described embodiment may be omitted, replaced, or added in at least one of steps. For example, S103 process may be omitted. S108 process may be omitted. S113 process may be omitted. The process of S117 from S114 may be omitted. The control unit 11 may omit S115 and S116 processes, decide to stay in the facilities 36, and execute S117 processes. In S116, when the user U does not affirm the stay in the facility 36, the control unit 11 may proceed to S118. The control unit 11 may omit the processing of S120 and S121, decide to switch to the second route 32, and may shift to the processing after switching to the second route 32. S205 process may be omitted. S206 process may be omitted. S206 (whether or not a certain period of time has elapsed) may be changed as appropriate. The control unit 11 may omit the processes of S214 and S215, decide to switch the guidance route 35 to the shortest route 33, and execute S216 process. A series of processes from S204 to S217 may be omitted.

What is claimed is:

1. An information processing device comprising a control unit configured to:
acquire a first route to a destination from a search engine;
register the acquired first route as a guidance route;
acquire a current position;
provide guidance on a route to the destination corresponding to the acquired current position according to the guidance route registered;
repeatedly acquire the current position and provide guidance on the route until the acquired current position reaches the destination;
when the acquired current position is within a predetermined range from the destination, acquire a first expected arrival time at the destination by the guidance route, the first expected arrival time being calculated according to the current position;
when the acquired first expected arrival time is earlier than a desired arrival time and a first time difference between the first expected arrival time and the desired arrival time is more than a first threshold value, request the search engine to search for a second route from the current position to the destination, the second route allowing arrival at the destination that is later than by the first route and before the desired arrival time; and
suggest to a user to switch the guidance route to the second route acquired from the search engine.

2. The information processing device according to claim 1, wherein the control unit is further configured to suggest moving at a speed that is lower than a current movement speed when the first expected arrival time is earlier than the desired arrival time and the first time difference is less than the first threshold value.

3. The information processing device according to claim 1, wherein:
the search engine is requested to search for the second route when the first expected arrival time is earlier than the desired arrival time, the first time difference is more than the first threshold value, and the first time difference is less than a second threshold value that is larger than the first threshold value; and
the control unit is further configured to suggest staying at a facility that is present on the guidance route or near the guidance route when the first expected arrival time is earlier than the desired arrival time and the first time difference is more than the second threshold value.

4. The information processing device according to claim 1, wherein:
the control unit is further configured to, after the guidance route is switched to the second route in response to suggesting switching to the second route,
repeatedly acquire the current position and provide guidance on the route until the acquired current position reaches the destination,
request the search engine to search for a shortest route from the acquired current position to the destination,
acquire a second expected arrival time at the destination by the guidance route, the second expected arrival time being calculated according to the acquired current position,
set a third threshold value according to a second time difference between a third expected arrival time at the destination by the shortest route acquired from the search engine and the second expected arrival time, and
suggest to the user to switch the guidance route to the shortest route when the second expected arrival time is earlier than the desired arrival time and a third time difference between the second expected arrival time and the desired arrival time is less than the third threshold value; and
the third threshold value is set to a smaller value as the second time difference is larger, and is set to a larger value as the second time difference is smaller.

5. A non-transitory storage medium storing a program causing a computer to execute an information processing method, the information processing method comprising:
acquiring a first route to a destination from a search engine;
registering the acquired first route as a guidance route;
acquiring a current position;
providing guidance on a route to the destination corresponding to the acquired current position according to the guidance route registered;
repeatedly acquiring the current position and providing guidance on the route until the acquired current position reaches the destination;
when the acquired current position is within a predetermined range from the destination, acquiring a first expected arrival time at the destination by the guidance route, the first expected arrival time being calculated according to the current position;
when the acquired first expected arrival time is earlier than a desired arrival time and a time difference between the first expected arrival time and the desired arrival time is more than a first threshold value, requesting the search engine to search for a second route from the current position to the destination, the second route allowing arrival at the destination that is later than by the first route and before the desired arrival time; and
suggesting to a user to switch the guidance route to the second route acquired from the search engine.
